(19) United States
(12) Patent Application Publication
(10) Pub. No.: US 2024/0151573 A1
(43) Pub. Date: May 9, 2024

(54) WEIGHT ESTIMATION METHOD, WEIGHT ESTIMATION DEVICE, WEIGHT ESTIMATION SYSTEM

(71) Applicant: NEC Corporation, Minato-ku, Tokyo (JP)

(72) Inventor: Hiroshi Yoshida, Tokyo (JP)

(73) Assignee: NEC Corporation, Minato-ku, Tokyo (JP)

(21) Appl. No.: 18/277,907

(22) PCT Filed: Feb. 26, 2021
(86) PCT No.: PCT/JP2021/007581

§ 371 Date: Aug. 18, 2023

(51) Int. Cl. G01G 9/00; E02F 9/26; G01G 17/04; G01G 19/08; G06T 7/60

(52) U.S. Cl. CPC G01G 9/00; E02F 9/26; G01G 17/04; G01G 19/08; G06T 7/60; G06T 2207/20081

(57) ABSTRACT

Provided is a technique which makes it possible to suitably evaluate a weight of a target object disposed in a container. A weight estimation method includes: a first obtaining step of obtaining first image data for training included in first type image data on a target object which has been scooped up by an excavator and is disposed in a container; a training step of training, with reference to the first image data and a measured weight of the target object, an estimation model that outputs a weight of the target object based on the first type image data; a second obtaining step of obtaining second image data for estimation included in the first type image data; and an estimating step of estimating the weight of the target object based on the estimation model and the second image data.

### TECHNICAL FIELD

The present invention relates to a weight estimation method, a weight estimation apparatus, and a weight estimation system.

### BACKGROUND ART

Conventionally, a method of, in construction work, civil engineering work, and the like, evaluating a weight of a target object which has been scooped up by a hydraulic excavator or the like, in a state where the target object is mounted on the hydraulic excavator or the like has been developed. For example, Patent Literature 1 discloses a load measurement apparatus which computes a plurality of load values based on values outputted from an angle sensor and a pressure sensor and then determines an optimum load value, the angle sensor detecting a front posture of a hydraulic excavator, the pressure sensor detecting a pressure of a hydraulic cylinder. Patent Literature 2 discloses that a volume of an excavated object in a bucket is estimated from an image captured by a camera.

### CITATION LIST

### Patent Literature

[Patent Literature 1] Japanese Patent Application Publication No. 2012-103029
[Patent Literature 2] International Publication No. WO2019/117166

### SUMMARY OF INVENTION

### Technical Problem

However, in the apparatus disclosed in Patent Literature 1, it is necessary to newly install a hydraulic sensor into an inside of a hydraulic system, and it is difficult to incorporate the hydraulic sensor into an existing hydraulic excavator. In a method disclosed in Patent Literature 2, it is not possible to evaluate a weight of the excavated object.

An example aspect of the present invention is for providing a technique which makes it possible to suitably evaluate a weight of a target object disposed in a container.

### Solution to Problem

A weight estimation method in accordance with an example aspect of the present invention is a weight estimation method including: a first obtaining step of obtaining first image data which is image data for training and which is included in first type image data that is image data on a target object which has been scooped up by an excavator and which is disposed in a container; a training step of training, with reference to the first image data and a measured weight of the target object, an estimation model that outputs a weight of the target object based on the first type image data; a second obtaining step of obtaining second image data which is image data for estimation and which is included in the first type image data; and an estimating step of estimating the weight of the target object based on the estimation model and the second image data.

A weight estimation apparatus in accordance with an example aspect of the present invention is a weight estimation apparatus including: a first obtaining means for obtaining first image data which is image data for training and which is included in first type image data that is image data on a target object which has been scooped up by an excavator and which is disposed in a container; a training means for training, with reference to the first image data and a measured weight of the target object, an estimation model that outputs a weight of the target object based on the first type image data; a second obtaining means for obtaining second image data which is image data for estimation and which is included in the first type image data; and an estimating means for estimating the weight of the target object based on the estimation model and the second image data.

A weight estimation system in accordance with an example aspect of the present invention is a weight estimation system including: a first obtaining means for obtaining first image data which is image data for training and which is included in first type image data that is image data on a target object which has been scooped up by an excavator and which is disposed in a container; a training means for training, with reference to the first image data and a measured weight of the target object, an estimation model that outputs a weight of the target object based on the first type image data; a second obtaining means for obtaining second image data which is image data for estimation and which is included in the first type image data; and an estimating means for estimating the weight of the target object based on the estimation model and the second image data.

### Advantageous Effects of Invention

According to an example aspect of the present invention, it is possible to provide a technique which makes it possible to suitably evaluate a weight of a target object disposed in a container.

### BRIEF DESCRIPTION OF DRAWINGS

FIG. 1 is a block diagram illustrating a configuration of a training apparatus in accordance with a first example embodiment of the present invention.

FIG. 2 is a flowchart illustrating a flow of a training method in accordance with the first example embodiment of the present invention.

FIG. 3 illustrates drawings for explaining first type image data and second type image data in accordance with the first example embodiment of the present invention.

FIG. 4 is a block diagram illustrating a configuration of an estimation apparatus in accordance with the first example embodiment of the present invention.

FIG. 5 is a flowchart illustrating a flow of an estimation method in accordance with the first example embodiment of the present invention.

FIG. 6 is a block diagram illustrating a configuration of a weight estimation apparatus in accordance with a second example embodiment of the present invention.

FIG. 7 is a flowchart illustrating a flow of a weight estimation method in accordance with the second example embodiment of the present invention.

FIG. 8 is a block diagram of a training system which trains a model that estimates a weight of earth and sand accommodated in a bucket, in accordance with a third example embodiment of the present invention.

FIG. 9 illustrates heat maps each showing an example of image data on the earth and sand accommodated in the bucket of a backhoe, in accordance with the third example embodiment of the present invention.

FIG. 10 illustrates drawings for explaining a theoretical weight estimation equation in accordance with a fourth example embodiment of the present invention.

FIG. 11 is a graph showing a result of kernel ridge regression on a measured value, in accordance with the fourth example embodiment of the present invention.

FIG. 12 is a block diagram of an estimation system that estimates a weight, in accordance with a fifth example embodiment of the present invention.

FIG. 13 is a block diagram of an information processing system that includes a training section, in accordance with a sixth example embodiment of the present invention.

FIG. 14 is a block diagram of another example of an information processing system that includes a switching section, in accordance with a seventh example embodiment of the present invention.

FIG. 15 illustrates two patterns of distribution of a maximum value of a kernel function.

FIG. 16 is a block diagram of an information processing system that is dispersed, in accordance with an eighth example embodiment of the present invention.

FIG. 17 is a drawing of a configuration in which each section is realized by software.

### DESCRIPTION OF EMBODIMENTS

### First Example Embodiment

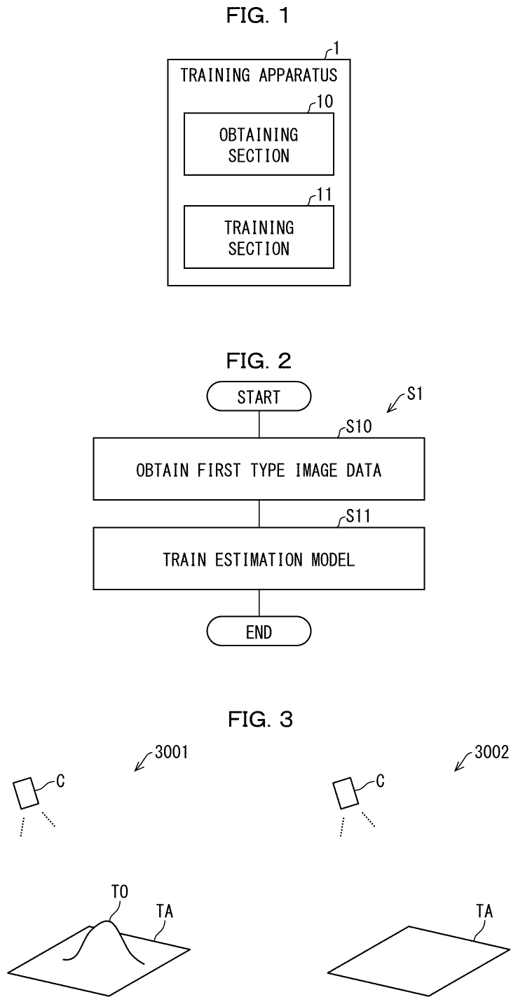

The following description will discuss, in detail, a first example embodiment of the present invention with reference to drawings. The present example embodiment is made the basis of example embodiments described later. FIG. 1 is a block diagram illustrating a configuration of a training apparatus 1 in accordance with the first example embodiment of the present invention. The training apparatus 1 is an apparatus which trains an estimation model that estimates a weight of a target object disposed in a container.

In the present example embodiment, there are (i) a case where the target object is disposed in the container and (ii) a case where the target object is not disposed in the container. In the present example embodiment, the container may be a bucket of an excavator. In the present example embodiment, the target object is a liquid or a granular or irregularly shaped solid each of which is placed or accommodated in the container. Examples of the target object include soil, sand, earth and sand, snow, grains, and cement, i.e., objects that can be placed in storage facilities and the like and objects that can be accommodated in containers. In the present example embodiment, the excavator is a machine which scoops up the target object such as soil, sand, earth and sand, snow, grains, and cement. The object to be scooped up is not limited to earth and sand and a rock.

(Configuration of Training Apparatus 1)

As illustrated in FIG. 1, the training apparatus 1 includes an obtaining section 10 and a training section 11. The obtaining section 10 obtains first type image data that is image data on the target object which has been scooped up by the excavator and which is disposed in the container. The first type image data is image data obtained in a state where the target object is disposed in the container. The training section 11 trains, with reference to the first type image data and a measured weight of the target object, the estimation model that estimates the weight of the target object. The measured weight of the target object is obtained by, for example, a weight measurement apparatus. Note that the obtaining section 10 is a form of an obtaining means recited in the claims, and the training section 11 is a form of a training means recited in the claims.

(First Type Image Data and Second Type Image Data)

FIG. 3 is for explaining the first type image data and second type image data. As illustrated in 3001 of FIG. 3, the first type image data is data obtained, by an image capturing apparatus C, in a state where a target object TO (Target Object) is disposed in a container TA (Target Area). As illustrated in 3002 of FIG. 3, data obtained, by the image capturing apparatus C, in a state where the target object TO is not disposed in the container TA is the second type image data.

Examples of the image capturing apparatus C include cameras, such as three-dimensional cameras, and three-dimensional scanners. The cameras include depth cameras and the like. The three-dimensional scanners include three-dimensional Lidar (Light Detection And Ranging) and the like. Image data indicates data obtained by the image capturing apparatus C such as a camera or a three-dimensional scanner. The image data may be, for example, image data in which a depth is represented by a color, a contour, or the like that varies depending on the depth.

The training section 11 trains the estimation model with use of training data (learning data) which includes a plurality of sets of (i) the first type image data that has been obtained by the image capturing apparatus C and (ii) the measured weight of the target object. In the present example embodiment, the estimation model is a model that outputs the weight of the target object based on the first type image data. For example, the estimation model may be such that the first type image data is inputted into the estimation model and then the estimation model outputs the weight of the target object. For example, the estimation model may be a model in which, for example, an algorithm such as a theoretical function, a regression function, or a convolutional neural network (CNN) is used.

Note that, in the present example embodiment, “train a model” can be expressed as “causes a model (which is a target of training) to be trained”.

In the example embodiment illustrated in FIG. 1, the obtaining section 10 and the training section 11 are incorporated in a single training apparatus 1. However, these sections do not necessarily need to be incorporated in a single training apparatus. For example, the obtaining section 10 and the training section 11 may be disposed separately. Then, these sections may be connected to each other by wired communication or wireless communication. Further, one or both of the obtaining section 10 and the training section 11 may be on a cloud. This respect also applies to apparatus configurations described below.

(Effects of Training Apparatus 1)

As has been described, the training apparatus 1 in accordance with the present example embodiment employs a configuration such that the training apparatus 1 includes: an obtaining section which obtains first type image data that is image data on a target object which has been scooped up by an excavator and which is disposed in a container; and a training section which trains, with reference to the first type image data and a measured weight of the target object, an estimation model that estimates a weight of the target object.

Therefore, the training apparatus 1 in accordance with the present example embodiment brings about an effect that it is possible to provide a technique which makes it possible to suitably evaluate the weight of the target object which has been scooped up by the excavator and which is disposed in the container.

Furthermore, it is possible to evaluate the weight of the target which has been scooped up by the excavator, in a state where the target object is accommodated in the container. It is therefore possible to improve working efficiency, as compared with a method of separately evaluating the target object with use of a weight measurement apparatus.

(Flow of Training Method S1)

Next, a flow of a training method S1 in accordance with the first example embodiment is described with reference to FIG. 2. The training method S1 is a method of training the estimation model that estimates the weight of the target object which has been scooped up by the excavator and which is disposed in the container. FIG. 2 is a flowchart illustrating the flow of the training method S1 carried out by the training apparatus 1. As illustrated in FIG. 2, the training method S1 includes the following steps. First, in a step S10 (obtaining step), the obtaining section 10 obtains the first type image data that is image data on the target object which has been scooped up by the excavator and which is disposed in the container. For example, the obtaining section 10 obtains the first type image data which has been obtained by the image capturing apparatus C. Note that a method by which the obtaining section obtains the image data from the image capturing apparatus C is not limited. For example, the obtaining section 10 can obtain the first type image data from the image capturing apparatus C with use of wired communication, wireless communication, or a combination of wired communication and wireless communication.

Next, in a step S11 (training step), the training section 11 trains, with reference to the first type image data and the measured weight of the target object, the estimation model that estimates the weight of the target object. For example, the training section 11 trains the estimation model with reference to (i) the first type image data which has been obtained in the step S10 and (ii) the measured weight of the target object which weight has been measured by, for example, the weight measurement apparatus. Detailed examples of the estimation model is described later.

(Effect of Training Method S1)

As has been described, the training method S1 in accordance with the present example embodiment employs a configuration such that the training method S1 includes: obtaining first type image data that is image data on a target object which has been scooped up by an excavator and which is disposed in a container; and training, with reference to the first type image data and a measured weight of the target object, an estimation model that estimates a weight of the target object.

Therefore, the training method S1 in accordance with the present example embodiment brings about an effect that it is possible to provide a technique which makes it possible to suitably evaluate the weight of the target object which has been scooped up by the excavator and which is disposed in the container.

(Configuration of Estimation Apparatus)

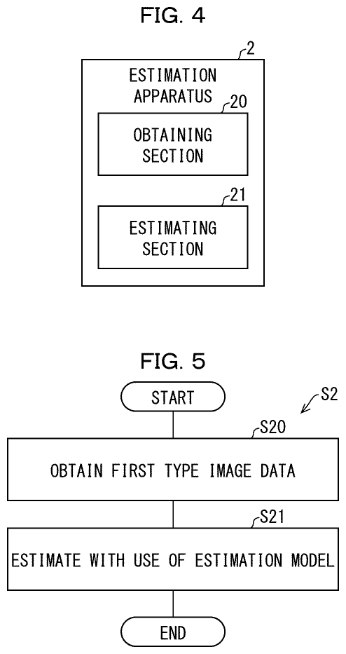

Next, a configuration of an estimation apparatus 2 in accordance with the first example embodiment is described with reference to a drawing. FIG. 4 is a block diagram illustrating the configuration of the estimation apparatus 2. The estimation apparatus 2 estimates, with use of the estimation model, the weight of the target object which is disposed in the container.

As illustrated in FIG. 4, the estimation apparatus 2 includes an obtaining section 20 and an estimating section 21. The obtaining section 20 obtains the first type image data that is image data on the target object which has been scooped up by the excavator and which is disposed in the container. The estimating section 21 estimates the weight of the target object with reference to the first type image data which has been obtained by the obtaining section 20. For example, the estimating section 21 estimates the weight of the target object with use of the estimation model which has been trained by the training section 11 of the training apparatus 1 described above. Detailed examples of the estimation model used by the estimating section 21 is described later.

As has been described, the estimation apparatus 2 in accordance with the first example embodiment employs a configuration such that the estimation apparatus 2 includes: the obtaining section 20 which obtains first type image data that is image data on a target object which has been scooped up by an excavator and which is disposed in a container; and the estimating section 21 which estimates a weight of the target object with reference to the first type image data which has been obtained by the obtaining section 20. Therefore, the estimation apparatus 2 in accordance with the first example embodiment brings about an effect that it is possible to provide a technique of evaluating the weight of the target object that is disposed in various regions, with use of information which has been obtained by capturing an image of the target object.

The obtaining section 20 and the estimating section 21 of the estimation apparatus 2 and the obtaining section 10 and the training section 11 of the training apparatus 1 may be mounted on the same apparatus.

(Flow of Estimation Method S2)

Next, a flow of an estimation method S2 in accordance with the first example embodiment is described with reference to FIG. 5. The estimation method S2 is a method of estimating the weight of the target object which has been scooped up by the excavator and which is disposed in the container. FIG. 5 is a flowchart illustrating the flow of the estimation method S2 carried out by the estimation apparatus 2. As illustrated in FIG. 5, the estimation method S2 includes the following steps. First, in a step S20 (obtaining step), the obtaining section 20 obtains the first type image data that is image data on the target object which has been scooped up by the excavator and which is disposed in the container. This step S20 is similar to the obtaining step S10 in the training method S1 described above. Next, in a step S21, the estimating section 21 estimates the weight of the target object with use of the estimation model that outputs the weight of the target object based on the first type image data. The estimation model may be the estimation model that has been trained in the step S11 in the training method S1 described above.

As has been described, the estimation method S2 in accordance with the first example embodiment employs a configuration such that the estimation method S2 includes: obtaining first type image data that is image data on a target object which has been scooped up by an excavator and which is disposed in a container; and estimating a weight of the target object with use of an estimation model that outputs the weight of the target object based on the first type image data.

Therefore, the estimation method S2 in accordance with the first example embodiment brings about an effect that it is possible to provide a technique which makes it possible to suitably evaluate the weight of the target object which is disposed in the container.

### Second Example Embodiment

(Configuration of Weight Estimation Apparatus 100)

Next, a weight estimation apparatus 100 in accordance with a second example embodiment is described with reference to drawings. Descriptions of elements having the same functions as those of the elements described in the first example embodiment will be omitted as appropriate.

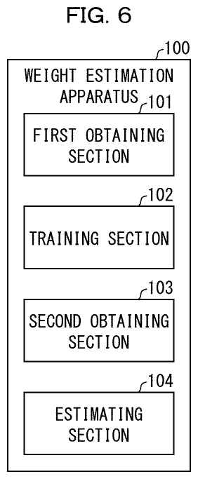

FIG. 6 is a block diagram illustrating a configuration of the weight estimation apparatus 100 in accordance with the present example embodiment. As illustrated in FIG. 6, the weight estimation apparatus 100 includes a first obtaining section 101, a training section 102, a second obtaining section 103, and an estimating section 104.

The first obtaining section 101 obtains first image data which is image data for training and which is included in first type image data that is image data on a target object which has been scooped up by an excavator and which is disposed in a container. As an example, the first obtaining section 101 is a configuration corresponding to the obtaining section 10 in the first example embodiment. Since the first type image data has been described in the first example embodiment, further description thereof is omitted here.

The training section 102 trains, with reference to the first image data and a measured weight of the target object, an estimation model that outputs a weight of the target object based on first type image data. As an example, the training section 102 is a configuration corresponding to the training section 11 in the first example embodiment. Since the estimation model has been described in the first example embodiment, further description thereof is omitted here.

The second obtaining section 103 obtains second image data which is image data for estimation and which is included in the first type image data. As an example, the second obtaining section 103 is a configuration corresponding to the obtaining section 20 in the first example embodiment.

The estimating section 104 estimates the weight of the target object based on the estimation model and the second image data. As an example, the estimating section 104 is a configuration corresponding to the estimating section 21 in the first example embodiment.

In the example embodiment illustrated in FIG. 6, the first obtaining section 101, the training section 102, the second obtaining section 103, and the estimating section 104 are incorporated in a single weight estimation apparatus 100. However, these sections do not necessarily need to be incorporated in a single weight estimation apparatus. For example, the first obtaining section 101, the training section 102, the second obtaining section 103, and the estimating section 104 may be disposed separately. Then, these sections may be connected to each other by wired communication or wireless communication. Further, one or both of the training section 102 and the estimating section 104 may be on a cloud. Further, functions of the first obtaining section 101 and the second obtaining section 103 may be realized by a single obtaining section.

(Effect of Weight Estimation Apparatus 100)

As has been described, the weight estimation apparatus 100 in accordance with the present example embodiment brings about an effect that it is possible to provide a technique which makes it possible to suitably evaluate a weight of a target object which has been scooped up by an excavator and which is disposed in a container.

(Additional Remarks on Weight Estimation Apparatus 100)

Note that the first obtaining section 101 may be configured to further obtain third image data which is image data for training and which is included in second type image data that is image data on an inside of the container before the target object is scooped up. Here, the expression “image data on an inside of the container before the target object is scooped up” is not intended to specify a timing at which the image data is obtained, but to specify a situation in the container. More specifically, in the “container before the target object is scooped up”, the target object does not exist, or only a slight remaining target object exists. Therefore, the expression “image data on an inside of the container before the target object is scooped up” can be referred to as “image data in a case where the target object does not exist in the container or a slight remaining target object exists in the container”.

The estimation model may output the weight of the target object based on the first type image data and the second type image data.

The training section 102 may be configured to train the estimation model further with reference to the third image data.

The second obtaining section 103 may be configured to further obtain fourth image data which is image data for estimation and which is included in the second type image data.

The estimating section 104 may be configured to estimate the weight of the target object based on the estimation model, the second image data, and the fourth image data.

According to the above configuration, the weight of the target object is estimated with use of the estimation model that outputs the weight of the target object based on the first type image data and the second type image data. Therefore, it is possible to more suitably evaluate the weight of the target object.

(Flow of Weight Estimation Method S100)

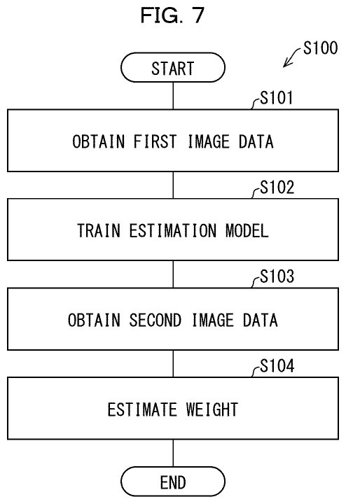

Next, a flow of a weight estimation method S100 in accordance with the second example embodiment is described. FIG. 7 is a flowchart illustrating the flow of the weight estimation method S100 carried out by the weight estimation apparatus 100. As illustrated in FIG. 7, the weight estimation method S100 includes the following steps.

First, in a step S101 (first obtaining step), the first obtaining section 101 obtains the first image data which is image data for training and which is included in the first type image data that is image data on the target object which has been scooped up by the excavator and which is disposed in the container.

Next, in a step S102 (training step), the training section 102 trains, with reference to the first image data and the measured weight of the target object, the estimation model that outputs the weight of the target object based on the first type image data.

Next, in a step S103 (second obtaining step), the second obtaining section 103 obtains the second image data which is image data for estimation and which is included in the first type image data.

Next, in a step S104 (estimating step), the estimating section 104 estimates the weight of the target object based on the estimation model and the second image data.

(Effect of Weight Estimation Method S100)

As has been described, the weight estimation method S100 in accordance with the present example embodiment brings about an effect that it is possible to provide a technique which makes it possible to suitably evaluate a weight of a target object which has been scooped up by an excavator and which is disposed in a container.

(Additional Remarks on Weight Estimation Method S100)

Note that the first obtaining step S101 may be configured such that the third image data is further obtained which is image data for training and which is included in the second type image data that is image data on the inside of the container before the target object is scooped up.

The weight of the target object may be outputted based on the estimation model, the first type image data, and the second type image data.

The training step S102 may be configured such that the estimation model is trained further with reference to the third image data.

The second obtaining step S103 may be configured such that the fourth image data is further obtained which is image data for estimation and which is included in the second type image data.

The estimating step S104 may be configured such that the weight of the target object is estimated based on the estimation model, the second image data, and the fourth image data.

According to the above configuration, the weight of the target object is estimated with use of the estimation model that outputs the weight of the target object based on the first type image data and the second type image data. Therefore, it is possible to more suitably evaluate the weight of the target object.

### Third Example Embodiment

(Configuration of Training System 300)

Next, a training system 300 in accordance with a third example embodiment is described with reference to drawings. Descriptions of elements having the same functions as those of the elements described in the first and second example embodiments will be omitted as appropriate.

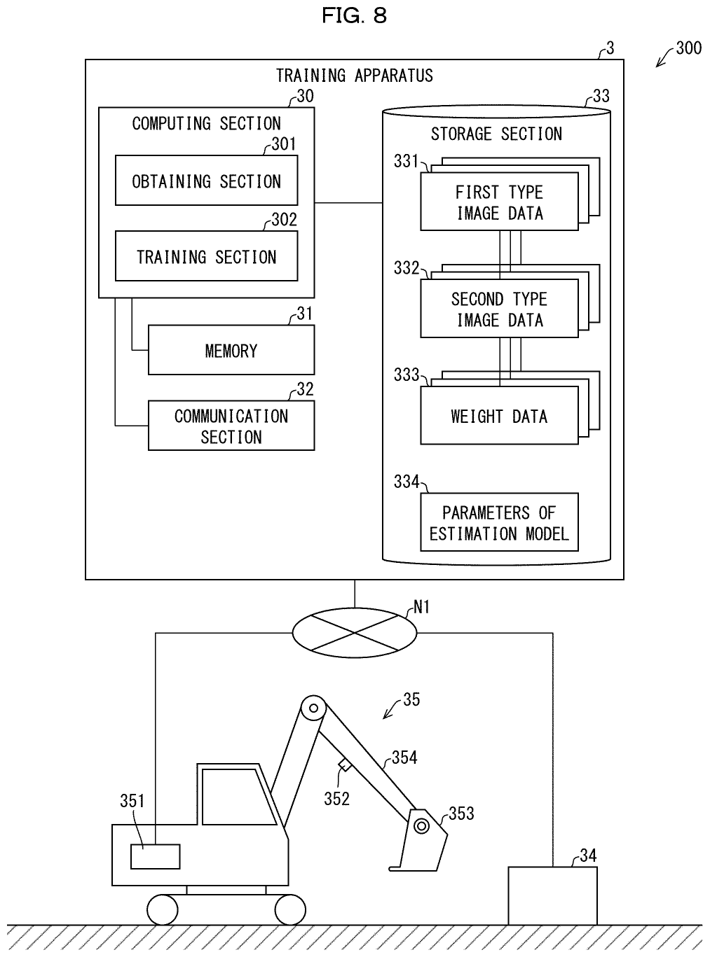

FIG. 8 is a block diagram illustrating a configuration of the training system 300 which trains an estimation model that estimates a weight of earth and sand accommodated in a bucket 353 of a backhoe 35. As illustrated in FIG. 8, the training system 300 includes a training apparatus 3. The training system 300 may further include a weight measurement apparatus 34 and the backhoe 35.

The training apparatus 3 includes a computing section 30, a memory 31, a communication section 32, and a storage section 33. The computing section 30 includes an obtaining section 301 and a training section 302. As an example, the obtaining section 301 and the training section 302 are equivalent to the obtaining section 10 and the training section 11, respectively, described in the first example embodiment. As another example, the obtaining section 301 and the training section 302 are equivalent to the obtaining section (first obtaining section 101) and the training section 102, respectively, described in the second example embodiment. Therefore, descriptions of these sections are omitted here.

In the memory 31, a program which is executed by the computing section 30 and various pieces of data, parameters, or the like which are referred to by the computing section 30 are transitorily or non-transitorily recorded. The communication section 32 carries out data communication with a controller 351 of the backhoe 35 or a communication section that is not illustrated, via a wireless communication network N1.

In the storage section 33, various pieces of data for the training section 302 to train the estimation model are recorded. Specifically, first type image data 331, second type image data 332, weight data 333, parameters 334 of the estimation model, and the like are recorded in the storage section 33. The first type image data 331 and the second type image data 332 are as described in the first example embodiment. The weight data 333 is data obtained by the weight measurement apparatus 34 measuring the earth and sand accommodated in the bucket 353 of the backhoe 35 (described later). The parameters 334 of the estimation model are various parameters included in a function equation of the estimation model.

The weight measurement apparatus 34 measures the weight of the earth and sand accommodated in the bucket 353. The weight measurement apparatus 34 can carry out data communication with the training apparatus 3 via the wireless communication network N1. The weight measurement apparatus 34 may be configured such that the weight measurement apparatus 34 can communicate with the controller 351 of the backhoe 35 by wire or wireless and carry out data communication with the training apparatus 3 via the controller 351. The weight measurement apparatus 34 may be an apparatus that detects a strain in a component which strain is caused by placing, for example, the earth and sand and that measures the weight of the earth and sand. Alternatively, the weight measurement apparatus 34 may be an apparatus that measures a weight of the entire backhoe 35. In the latter case, the weight measurement apparatus 34 measures (i) the weight of the backhoe 35 before the backhoe 35 scoops up the earth and sand with use of the bucket 353 and (ii) the weight of the backhoe 35 after the backhoe 35 has scooped up the earth and sand with use of the bucket 353, and then transmits, to the training apparatus 3, the weight before and after the scoop of the earth and sand. The training apparatus 3 can calculate the weight of the earth and sand from the weight of the backhoe 35 before and after the scoop of the earth and sand.

The backhoe 35 is an excavator that excavates the earth and sand with use of the bucket 353 and moves the excavated earth and sand to a given position. The backhoe 35 includes the controller 351 that can carry out data communication with the training apparatus 3 via the wireless communication network N1. The backhoe 35 also includes a depth camera 352 that is located at a position where the depth camera 352 can capture an image of an object accommodated in the bucket 353. In the present example embodiment, image data is data obtained by the depth camera. The data obtained by the depth camera is, for example, data indicating a distance between the depth camera (i.e., image capturing means) and the target object. The depth camera 352 can generate the image in which information on a depth (distance from the depth camera 352) is included. A method of obtaining the information on the depth is not limited. Examples of the method include a parallactic angle method, a time of flight (TOF) method, and a pattern method of detecting a pattern of a reflected wave of a dot-like or striped light beam. The depth camera 352 is mounted, for example, on a middle portion of an arm 354 so as to face in a direction of the bucket 353.

In the third example embodiment, the second type image data 332 recorded in the storage section 33 is image data on the bucket 353 before the earth and sand are scooped up. The second type image data is obtained by the depth camera 352 capturing an image in a state where the bucket 353 is pivoted so that an inner surface of the bucket 353 faces in a direction of the depth camera 352. A pivoting angle of the bucket 353 with respect to the arm 354 when the depth camera obtains the second type image data is recorded in the storage section 33.

On the other hand, the first type image data 331 is image data on the bucket 353 after the earth and sand have been scooped up. The pivoting angle of the bucket 353 with respect to the arm 354 when the depth camera obtains the first type image data is the same as the pivoting angle of the bucket 353 when the depth camera obtains the second type image data.

FIG. 9 illustrates heat maps each showing an example of the image data on the bucket 353 which image data has been obtained by the depth camera 352. 7001 of FIG. 9 is the image data (second type image data) on the bucket 353 in a state where the earth and sand are not accommodated therein. 7002 of FIG. 9 is the image data (first type image data) on the bucket 353 in a state where the earth and sand are accommodated therein. In FIG. 9, a darker black color indicates that a depth of the bucket 353 is greater, i.e., a smaller amount of the earth and sand are accommodated in the bucket 353. A front side of the bucket 353 is a tilted surface. Therefore, as illustrated in 7001, there is a difference in depth even in the state where the earth and sand are not accommodated in the bucket 353.

In the storage section 33, the first type image data after the earth and sand have been accommodated, the second type image data before the earth and sand are accommodated, and the weight data on the accommodated earth and sand are recorded in association with each other as a dataset. The obtaining section 301 repeatedly obtains the dataset of the first type image data 331, the second type image data 332, and the weight data 333. In the storage section 33, such a plurality of datasets are each recorded as training data.

The training section 302 trains the estimation model with use of the training data (learning data). Specifically, the training section 302 trains the estimation model further with reference to the second type image data 332 that is image data on an inside of the container in a situation where the target object is not disposed therein, in addition to the first type image data 331, as the learning data. Training is, as an example, updating the parameters based on the estimation model, first image data, and second image data so that a weight value to be outputted becomes as close as possible to the weight data that has been actually measured. Note that the second type image data 332 is image data on the bucket 353 in an empty state. Therefore, the second type image data that has been first obtained may be used in common thereafter. More specifically, in a step of repeatedly training the estimation model, the second type image data that has been first obtained may be used again in subsequent training of the estimation model. In this case, the estimation model can be trained with reference to the first type image data that has been newly obtained and the weight data that has been newly measured. Detailed examples of the estimation model trained by the training section 302 and the parameters thereof are described later.

A flow of a training method carried out by the training system 300 is, as an example, as follows. First, the obtaining section 301 obtains the first type image data and the second type image data. Either of the first type image data and the second type image data may be obtained first. Next, the training section 302 trains the estimation model with reference to the first type image data and the second type image data.

(Effects of Training System 300)

As has been described, the training system 300 in accordance with the third example embodiment employs a configuration such that the training system 300 includes: an obtaining section which obtains first type image data that is image data on a target object which has been scooped up by an excavator and which is disposed in a container; and a training section which trains, with reference to the first type image data and a measured weight of the target object, an estimation model that estimates a weight of the target object.

Therefore, the training system 300 in accordance with the present example embodiment brings about an effect that it is possible to provide a technique which makes it possible to suitably evaluate the weight of the target object which has been scooped up by the excavator and which is disposed in the container. Note that more accurate training can be carried out by training the estimation model further with reference to the second type image data. Further, accurate training can also be carried out, for example, even in a case where the container is not horizontal (i.e., in a state where the container has a ridge or a dent).

### Fourth Example Embodiment

(Various Estimation Models)

Next, estimation models in accordance with a fourth example embodiment are described with reference to drawings. The estimation models described in the present example embodiment are detailed examples of the estimation model trained by the training section 11 of the training apparatus 1, the estimation model used by the estimating section 21 of the estimation apparatus 2 so as to estimate a weight, and the estimation model trained by the training section 302 of the training system 300. The estimation models are also detailed examples of an estimation model that is trained by a training system described below or used by an estimation system described below. Note, however, that the estimation models are not limited to those described below. Note that descriptions of elements having the same functions as those of the elements described in the first through third example embodiments will be omitted as appropriate.

(1) Theoretical Equation Model

First, a theoretical equation model based on a theoretical equation is described with reference to a drawing. The theoretical equation in the present example embodiment is a theoretical equation that derives a weight of a target object from a value obtained from first type image data and second type image data. The theoretical equation is derived from an equation for determining a volume of a cone formed between (i) a region of which an image has been captured and (ii) an image capturing apparatus. That is, a volume of a cone which volume is determined from the image data (first type image data) obtained after the target object has been scooped up is subtracted from a volume of a cone which volume is determined from the image data (second type image data) obtained before the target object is scooped up. As a result, a volume of the disposed target object is calculated. The weight of the target object is calculated by multiplying the volume of the target object by specific gravity of the target object.

The volume of the cone can be calculated as follows: the region of which the image has been captured is divided into micro regions; a volume of a micro cone formed between each micro region and the image capturing apparatus is approximated and determined; and then volumes of all micro cones are integrated. An example thereof will be described below in detail.

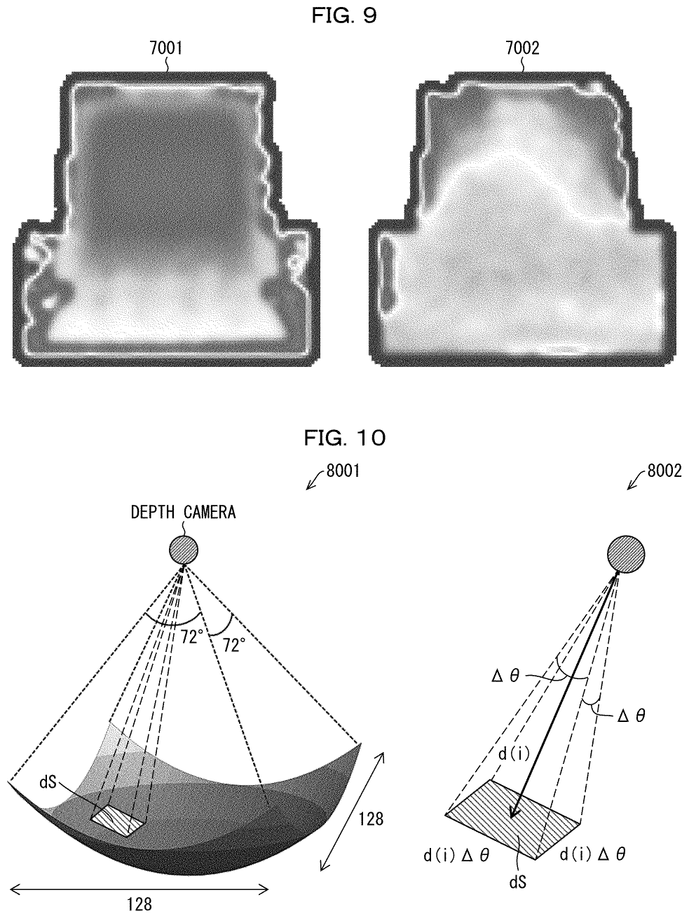

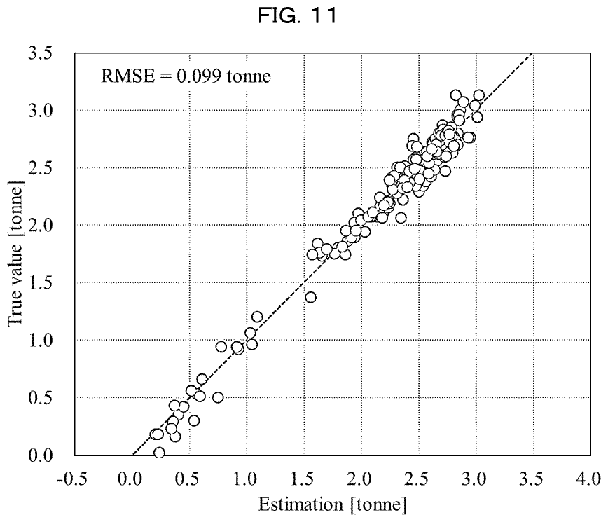

FIG. 10 shows, for example, how to consider an estimation equation that estimates a weight of earth and sand based on image data which has been obtained by a depth camera. As illustrated in 8001 of FIG. 10, it is assumed that a region of which an image is captured by the depth camera is square and an angle of view of one side is, for example, 72 degrees. Each side is divided into, for example, 128 sections so that the entire region is divided into 128×128=16,384 micro regions dS. At this time, as illustrated in 8002 of FIG. 10, a micro quadrangular pyramid in which a micro region dS is a base and a position of the depth camera is a vertex is considered, and a distance (height) from the vertex to the base dS is defined as d(i). In this case, a vertex angle of a lateral face is so minute that 40=72/128 (degrees). Therefore, a length of one side of the base is approximated as d(i)Δθ, and an area of the base is expressed by (d(i)Δθ)². Therefore, a volume ΔV(i) of this micro quadrangular pyramid is approximated as follows with use of a formula “an area of a base×a height×(⅓)”.

ΔV(i)≃⅓d(i)³(Δθ)²

It is assumed that a distance from a depth camera 352 to a bottom surface of a bucket 353 which distance has been measured in a state where the earth and sand exist in the bucket 353 is defined as e(i), and a distance from the depth camera 352 to a surface of the earth and sand which distance has been measured in a state where the earth and sand do not exist in the bucket 353 is defined as d(i). In this case, a volume V of the earth and sand is expressed by the following equation (1), and the weight W of the earth and sand is expressed by the following equation (2). That is, the theoretical equation that estimates the weight is expressed by the equation (2) including the equation (1). Here, y is specific gravity of the earth and sand. Note that specific gravity of typical dry earth and sand is approximately 1.3. Specific gravity can be arbitrarily set depending on a type of the target object.

$$\begin{matrix}V = {\sum }_{i} Δ V ( i ) \\ = \frac{1}{3} {( Δθ )}^{2} {\sum }_{i} ( {e ( i )}^{3} - {d ( i )}^{3} )\end{matrix} \qquad Equation ( 1 )$$

$$W = γ V \qquad Equation ( 2 )$$

A weight was calculated by substituting, into the above equation (2), (i) a distance obtained by capturing an image of an empty bucket with use of a depth camera and (ii) a distance obtained by capturing, with use of the depth camera, an image of earth and sand which had been scooped up with use of the bucket. The weight and an actually measured weight of the earth and sand were then compared with use of 212 datasets. As a result, a root mean square error (RMSE) was 0.396 as an example.

(2) Third-Degree Equation Simple Regression Estimation Model

This estimation model is a model in which simple regression on a third-degree term is performed. Specifically, the following equation (3) is used as a weight estimation equation using the simple regression model. That is, a₀ and a₁ (each of which is a constant) in the following equation (3) are determined by simple regression using a least squares method. The simple regression makes it possible to cause (i) a systematic error such as a measurement error in a depth camera and (i) an error such as an error in specific gravity to be small, as compared with a method of making estimation from the above theoretical equation.

$$W = {a}_{0} + {a}_{1} {\sum }_{i} ( {e ( i )}^{3} - {d ( i )}^{3} ) \qquad Equation ( 3 )$$

Here, it is assumed that an explanatory variable vₙ is the following equation (4) and a response variable is wₙ. In this case, a₀ and a₁ are each determined by the following equation (5). Note that Var is a variance, Coy is a covariance, n is a data number of an obtained training dataset, and the response variable wₙ is a measured weight. Note also that e(i) and d(i) are each a value relating to earth and sand which are an estimation target, and, as described above, e(i) is a distance from the depth camera 352 to the bottom surface of the bucket 353 which distance has been measured in a state where the earth and sand exist in the bucket 353, while d(i) is a distance from the depth camera 352 to a surface of the earth and sand which distance has been measured in a state where the earth and sand do not exist in the bucket 353.

As shown by the equation (4), the explanatory variable vₙ is a value obtained from (i) first type image data in the obtained training dataset and (ii) second type image data in the obtained training dataset. Specifically, the explanatory variable vₙ is a difference between (i) the third power of e n (i) which is a value obtained from the first type image data belonging to the dataset n and (ii) the third power of dₙ(i) which is a value obtained from the second type image data belonging to the dataset n.

$${v}_{n} = {\sum }_{i} ( {{e}_{n} ( i )}^{3} - {{d}_{n} ( i )}^{3} ) \qquad Equation ( 4 )$$

$${a}_{1} = {Var ( v )}^{- 1} Cov ( v , w ) {a}_{0} = \overline{w} - \overline{v} {a}_{1} \qquad Equation ( 5 )$$

$$[ \begin{matrix}\begin{matrix}\begin{matrix}v = \{ {v}_{n} \} & w = \{ {w}_{n} \}\end{matrix} & \overline{v} = avg v\end{matrix} & \overline{w} = avg w\end{matrix} ]$$

Data is the same as the above data, and includes 212 datasets. Note, however, that the 212 datasets were divided into 10 groups, and 9 groups out of the 10 groups were used as training data, while a remaining 1 group was used as verification data. This operation was repeated 10 times while a group used as the verification data was changed. Then, errors between the regression equation and actually measured values were evaluated. As a result, an RMSE was 0.364 as an example.

(3) First-Degree Equation Simple Regression Estimation Model

This estimation model is a model in which simple regression is performed with use of a first-degree equation, instead of a third-degree equation. That is, in the following equation (6) which is an estimation equation that estimates a weight, a₀ and a₁ (each of which is a constant) are determined by simple regression using a least squares method. An explanatory variable vₙ is the following equation (7), and a response variable is wₙ. Descriptions of notation that has been already described are omitted.

In this example, how to determine a₀ and a₁ is as shown by the following equation (8). According to the above regression model based on the third-degree equation, an error is enlarged by the third-degree term. However, the first-degree equation model makes it possible to cause an error to be smaller. Data is the same as the above data, and includes 212 datasets. Further, a method of dividing the 212 datasets into 10 groups and then using the 10 groups as training data and verification data is the same as that described above. As a result, an RMSE was 0.353 as an example.

$$W = {a}_{0} + {a}_{1} {\sum }_{i} ( e ( i ) - d ( i ) ) \qquad Equation ( 6 )$$

$${v}_{n} = {\sum }_{i} ( {e}_{n} ( i ) - {d}_{n} ( i ) ) \qquad Equation ( 7 )$$

$${a}_{1} = {Var ( v )}^{- 1} Cov ( v , w ) {a}_{0} = \overline{w} - \overline{v} {a}_{1} \qquad Equation ( 8 )$$

$$[ \begin{matrix}\begin{matrix}\begin{matrix}v = \{ {v}_{n} \} & w = \{ {w}_{n} \}\end{matrix} & \overline{v} = avg v\end{matrix} & \overline{w} = avg w\end{matrix} ]$$

(4) Multiple Regression Estimation Model Including First-, Second-, and Third-Degree Equations

This estimation model is a model obtained by multiple regression of an equation that includes a first-degree term, a second-degree term, and a third-degree term. That is, in the following equation (9) which is an estimation equation that estimates a weight, a₀ and aᵣ (each of which is a constant) are determined by multiple regression. An explanatory variable is the following equation (10), and a response variable is wₙ. Descriptions of notation that has been already described are omitted.

In this example, a₀, a₁, a₂, and a₃ can be determined by the following equations (11) and (12). According to the model of this example, it is possible to cause an error to be further smaller by multiple regression of the equation that includes the first-degree term, the second-degree term, and the third-degree term. Data and a method of processing the data are the same as those described above. As a result, an RMSE was 0.273 as an example.

$$W = {a}_{0} + {\sum }_{r = 1}^{3} \{ {a}_{r} {\sum }_{i} ( {e ( i )}^{r} - {d ( i )}^{r} ) \} \qquad Equation ( 9 )$$

$${v}_{n}^{( r )} = {\sum }_{i} ( {{e}_{n} ( i )}^{r} - {{d}_{n} ( i )}^{r} ) \qquad Equation ( 10 )$$

$$[ \begin{matrix}{a}_{1} \\ {a}_{2} \\ {a}_{3}\end{matrix} ] = {[ \begin{matrix}Var ( {v}^{( 1 )} , {v}^{( 1 )} ) & Cov ( {v}^{( 1 )} , {v}^{( 2 )} ) & Cov ( {v}^{( 1 )} , {v}^{( 3 )} ) \\ Cov ( {v}^{( 2 )} , {v}^{( 2 )} ) & Var ( {v}^{( 2 )} , {v}^{( 2 )} ) & Cov ( {v}^{( 2 )} , {v}^{( 3 )} ) \\ Cov ( {v}^{( 3 )} , {v}^{( 1 )} ) & Cov ( {v}^{( 3 )} , {v}^{( 2 )} ) & Var ( {v}^{( 3 )} , {v}^{( 3 )} )\end{matrix} ]}^{- 1} [ \begin{matrix}Cov ( {v}^{( 1 )} , w ) \\ Cov ( {v}^{( 2 )} , w ) \\ Cov ( {v}^{( 3 )} , w )\end{matrix} ] \qquad Equation ( 11 )$$

$${a}_{0} = \overline{w} - {a}_{1} {\overline{v}}^{( 1 )} - {a}_{2} {\overline{v}}^{( 2 )} - {a}_{3} {\overline{v}}^{( 3 )} \qquad Equation ( 12 )$$

(5) Logarithm Multiple Regression Estimation Model

This estimation model is a model in which each term is logarithmically transformed so as to express nonlinearity. An explanatory variable is the following equation (13), a response variable is wₙ. A weight estimation equation using the multiple regression model is expressed by the following equation (14). A method of determining each coefficient is similar to that in the case of the multiple regression estimation model including the first-, second-, and third-degree equations described above. Note, however, that v^{(r)} (r=1, 2, 3) in the equation (14) relates to earth and sand which are an estimation target, and is defined by an equation obtained by removing a subscript n from the equation (10) described above.

The regression model described above is a linear regression model. By causing the model to be a nonlinear model as in this example, it is possible to improve accuracy. Data and a method of processing the data are the same as those described above. As a result, an RMSE was 0.250 as an example.

$$ln {v}_{n}^{( r )} = ln ( {\sum }_{i} ( {{e}_{n} ( i )}^{r} - {{d}_{n} ( i )}^{r} ) ) \qquad Equation ( 13 )$$

$$W = {a}_{0} + {a}_{1} ln {v}^{( 1 )} + {a}_{2} ln {v}^{( 2 )} + {a}_{3} ln {v}^{( 3 )} \qquad Equation ( 14 )$$

(6) Kernel Ridge Regression Estimation Model

This model is a ridge regression model (kernel ridge regression model) in which a kernel function is used. The kernel ridge regression estimation model can achieve even higher accuracy as a non-linear regression model. Various functions can be used as the kernel function, but here, a Gaussian kernel function is used. The Gaussian kernel function has an advantage of being capable of constituting an accurate estimation model. The Gaussian kernel function is expressed by the following equation (15).

k(xₙ,xₘ)=exp(−β∥xₙ−xₘ∥²) Equation (15)

Here, β is a hyperparameter of a real number of greater than 0, and is set by a user as appropriate.

An explanatory variable xₙ in the kernel ridge regression estimation model is expressed by the following equation (16). A response variable w is expressed by the following equation (17). Since notation has been described above, description thereof will not be repeated here.

In the kernel ridge estimation model, a Gram matrix K N is expressed by the following equation (18), and an estimation equation that estimates a weight is expressed by the following equation (19). Here, a regression coefficient (weighting factor) a appearing in the following equation (19) is determined by the following equation (20). Further, x in the equation (19) relates to earth and sand which are an estimation target, and is defined by an equation obtained by removing a subscript n from the equation (16).

Note that n is a data number and n=1, 2, . . . N. Here, N=212. Note also that i is a coordinate of data and i=1, 2, . . . , L. Here, L=128×128=16,384. Note also that λ is a hyperparameter of a real number that is a coefficient of a regularization term, and is set by a user as appropriate. When regression was performed with the kernel ridge regression estimation model as described above, an error became very small as shown in FIG. 11. An RMSE was 0.099 as an example. Note that the data and a method of processing the data are the same as those described above.

$${x}_{n} = {[ {x}_{n} ( 1 ) … {x}_{n} ( L ) ]}^{T} = {[ {e}_{n} ( 1 ) - {d}_{n} ( 1 ) … {e}_{n} ( L ) - {d}_{n} ( L ) ]}^{T} \qquad Equation ( 16 )$$

$$w = {[ {w}_{1} … {w}_{N} ]}^{T} \qquad Equation ( 17 )$$

$${K}_{N} = [ \begin{matrix}k ( {x}_{1} , {x}_{1} ) & … & l ( {x}_{1} , {x}_{N} ) \\ ⋮ & ⋱ & ⋮ \\ k ( {x}_{N} , {x}_{1} ) & … & k ( {x}_{N} , {x}_{N} )\end{matrix} ] \qquad Equation ( 18 )$$

$$W = {\sum }_{i}^{N} {a}_{i} k ( x , {x}_{i} ) \qquad Equation ( 19 )$$

$$a = {[ {a}_{1} … {a}_{N} ]}^{T} = {( {K}_{N} + λ {I}_{N} )}^{- 1} w \qquad Equation ( 20 )$$

### Fifth Example Embodiment

(Configuration of estimation system 400)

Next, an estimation system 400 in accordance with a fifth example embodiment is described with reference to a drawing. The estimation system 400 is a system which estimates a weight of earth and sand accommodated in a bucket 443 of a backhoe 44. Note that descriptions of elements having the same functions as those of the elements described in the first through fourth example embodiments will be omitted as appropriate.

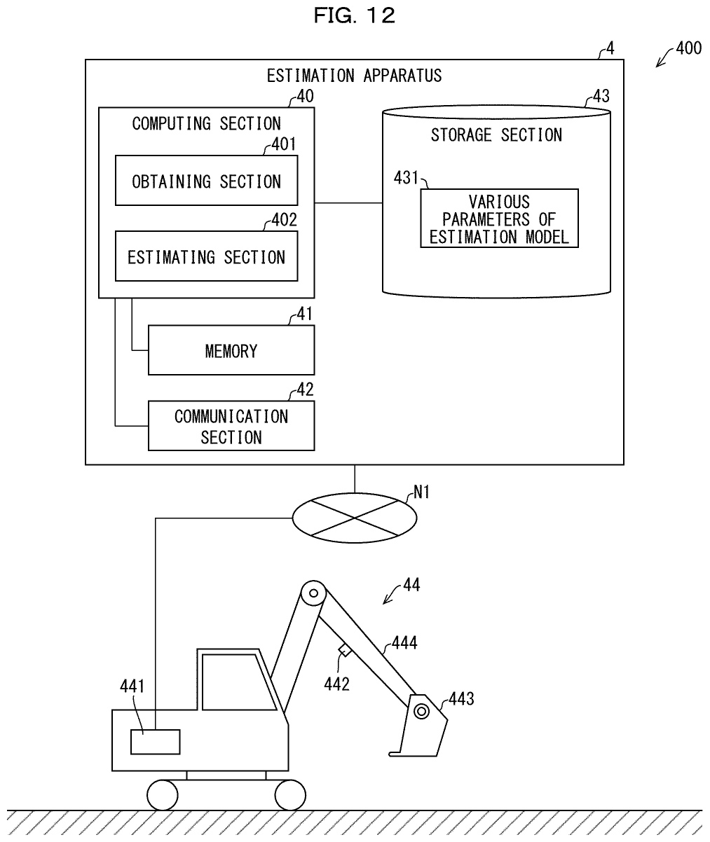

FIG. 12 is a block diagram illustrating a configuration of the estimation system 400. As illustrated in FIG. 12, the estimation system 400 includes an estimation apparatus 4. The estimation system 400 may further include the backhoe 44.

The estimation apparatus 4 includes a computing section 40, a memory 41, a communication section 42, and a storage section 43. The computing section 40 includes an obtaining section 401 and an estimating section 402. As an example, the obtaining section 401 and the estimating section 402 are equivalent to the obtaining section 20 and the estimating section 21, respectively, described in the first example embodiment. As another example, the obtaining section 401 and the estimating section 402 are equivalent to the obtaining section (the first obtaining section 101, the second obtaining section 103) and the estimating section 104, respectively, described in the second example embodiment. As an example, the estimating section 402 may use an estimation model which is described in the fourth example embodiment and which has been trained by the training section 302 of the training apparatus 3 described in the third example embodiment. The estimation model includes a regression model (the regression estimation model described in the fourth example embodiment) and a theoretical model (the theoretical equation model described in the fourth example embodiment). In the regression model, a value obtained from first type image data and second type image data is an explanatory variable, and a weight of a target object is a response variable. The theoretical model is based on a theoretical equation.

Note that the estimation model used by the estimating section 402 may include both of the theoretical model and the regression model. For example, the estimating section 402 may estimate the weight by weighting and averaging a result of the regression model that includes ridge regression and a result of the theoretical equation. The estimating section 402 may estimate the weight by weighting and averaging a ridge regression model and another regression model. In a case where the estimating section 402 uses a plurality of models as the estimation model, the estimating section 402 may be configured to use a value obtained by averaging or weighting and averaging outputs from the plurality of models.

In the memory 41, a program which is executed by the computing section 40 and various pieces of data, parameters, or the like which are referred to by the computing section 40 are transitorily or non-transitorily recorded. The communication section 42 carries out data communication with a controller 441 of the backhoe 44 or a communication section that is not illustrated, via a wireless communication network N1.

In the storage section 43, various parameters 431 of the estimation model included in the estimating section 402 are recorded. As an example, the various parameters 431 may be parameters of the estimation model which is described in the fourth example embodiment and which has been trained and is recorded in the storage section 33 of the training apparatus 3 described in the third example embodiment.

The backhoe 44 includes the controller 441 that can carry out data communication with the estimation apparatus 4 via the wireless communication network N1. The backhoe 44 also includes a depth camera 442 that is located at a position where the depth camera 442 can capture an image of an object accommodated in the bucket 443. The depth camera 442 is mounted, for example, on a middle portion of an arm 444 so as to face in a direction of the bucket 443.

The backhoe 44 is configured such that the bucket 443 that is empty is disposed at a given angle with respect to the arm 444 and the depth camera 442 captures an image. That is, image data includes data obtained by the depth camera 442. Thus, second image data is obtained. This angle is an angle at which the bucket 443 is disposed such that an inside thereof faces the depth camera 442. The backhoe 44 is also configured such that the bucket 443 in which the earth and sand have been scooped is disposed at a given angle with respect to the arm 444 and the depth camera 442 captures an image. Thus, first image data is obtained. These operations may be carried out by the controller 441 or may be carried out by an operator.

The first image data and the second image data thus obtained are transmitted from the controller 441 to the estimation apparatus 4 via the wireless communication network N1, and are then obtained by the obtaining section 401. As an example, the estimating section 402 inputs the first image data and the second image data which have been obtained by the obtaining section 401 into the estimation model that is used by the estimating section 402. The estimating section 402 may output, to an outside, a weight value outputted from the estimation model. For example, the weight value may be transmitted to a monitoring center (not illustrated) and may be displayed on a display apparatus. A user (or the operator) can use this information (the weight value) to evaluate a workload.

(Operation of Estimation System 400)

Next, an operation (estimation method) of the estimation system 400 is described. First, the obtaining section 401 obtains the first type image data that is image data on the target object which has been scooped up by an excavator and which is disposed in a container. The obtaining section 401 further obtains the second type image data that is image data on an inside of the container in a situation where the target object is not disposed therein. Next, the estimating section 402 estimates the weight of the target object with use of, as the estimation model, a model that outputs the weight of the target object based on the first type image data and the second type image data. In the present example embodiment, the container is the bucket 443. The target object is the earth and sand that are scooped up with use of the bucket 443. The first type image data is image data on the bucket 443 in a state where the earth and sand are scooped in the bucket 443. The second type image data is image data on the bucket 443 that is empty.

(Effect of Estimation System 400)

As has been described, the estimation system 400 employs a configuration such that the obtaining section 401 obtains first type image data and second type image data each of which is image data on a target object and the estimating section 402 estimates a weight of the target object with use of, as an estimation model, a model that outputs the weight of the target object based on the first type image data and the second type image data.

Therefore, according to the estimation system 400 in accordance with the fifth example embodiment, it is possible to provide a technique which makes it possible to suitably evaluate the weight of the target object which has been scooped up by an excavator and which is disposed in a container.

### Sixth Example Embodiment

(Configuration of Information Processing System 500)

Next, an information processing system 500 in accordance with a sixth example embodiment is described with reference to a drawing. The information processing system 500 is a system which estimates a weight of earth and sand accommodated in a bucket 553 of a backhoe 55 and which trains an estimation model. Note that descriptions of elements having the same functions as those of the elements described in the first through fifth example embodiments will be omitted as appropriate.

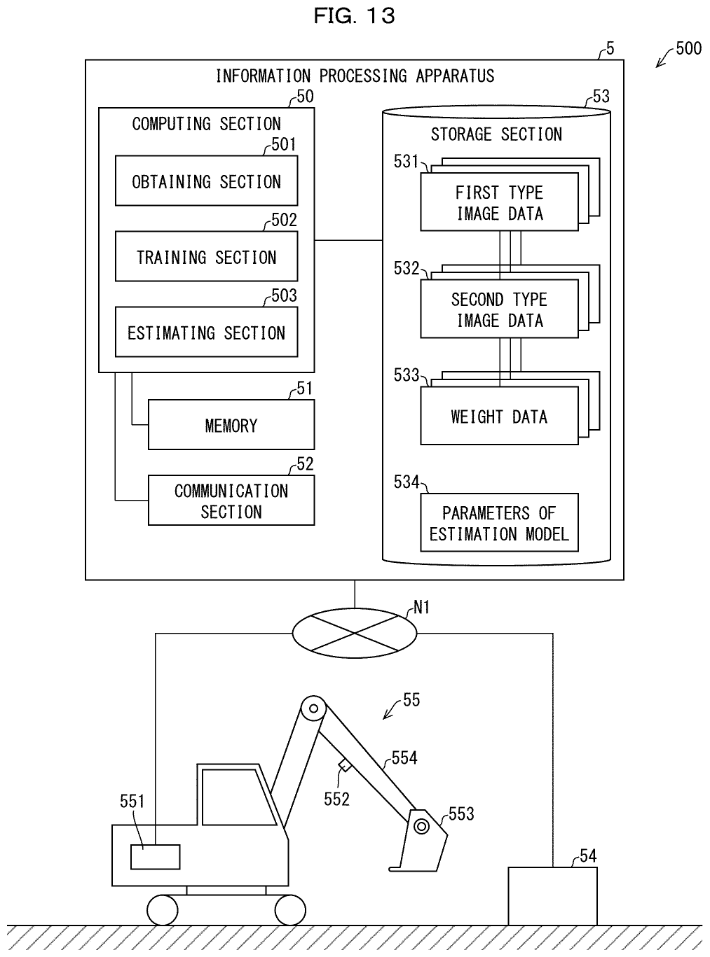

FIG. 13 is a block diagram illustrating a configuration of the information processing system 500. As illustrated in FIG. 13, the information processing system 500 includes an information processing apparatus 5. The information processing system 500 may further include a weight measurement apparatus 54 and the backhoe 55.

The information processing apparatus 5 includes a computing section 50, a memory 51, a communication section 52, and a storage section 53. The computing section 50 includes an obtaining section 501, a training section 502, and an estimating section 503. The obtaining section 501 and the estimating section 503 are equivalent to the obtaining section 401 and the estimating section 402, respectively, described in the fifth example embodiment. Therefore, descriptions of these sections are omitted. The memory 51, the communication section 52, the backhoe 55, a controller 551 included in the backhoe 55, and a depth camera 552 included in the backhoe 55 are equivalent to respective corresponding elements described in the fifth example embodiment. Therefore, descriptions of these sections are omitted.

The information processing system 500 differs from the estimation apparatus 4 in accordance with the fifth example embodiment in that the information processing system 500 includes the training section 502. The storage section 53 differs from the storage section 43 in that first type image data 531, second type image data 532, and weight data 533, in addition to parameters 534 of the estimation model, are recorded in the storage section 53. The training section 502 is equivalent to the training section 302 of the training system 300 in accordance with the third example embodiment. The first type image data 531, the second type image data 532, and the weight data 533 recorded in the storage section are equivalent to the first type image data 331, the second type image data 332, and the weight data 333, respectively, recorded in the storage section 33 of the training system 300 in accordance with the third example embodiment.

(Operation of Information Processing System 500)

The training section 502 of the information processing system 500 in accordance with the sixth example embodiment trains the estimating section 503 with reference to at least the first type image data and a measured weight of a target object. That is, the training section 502 trains the estimation model that is used by the estimating section 503, with use of, as learning data, at least (i) the image data on the bucket 553 after the earth and sand have been scooped up and (ii) an actually measured value of the weight of the earth and sand. The estimating section 503 estimates the weight of the earth and sand which have been scooped up with use of the bucket 553, with use of the estimation model that has been trained by the training section 502.

Note that, even after the training section 502 has trained the estimation model, the training section 502 can further train the estimation model with use of, as the learning data, at least (i) the image data on the bucket 553 after the earth and sand have been scooped up and (ii) the actually measured value of the weight of the earth and sand.

(Effects of Information Processing System 500)

As has been described, the information processing system 500 employs a configuration such that the training section 502 trains an estimation model which is used by the estimating section 503, with use of, as learning data, an actually measured value of a weight of earth and sand and image data on the bucket 553 before and after scoop of the earth and sand.

Therefore, according to the information processing system 500 in accordance with the sixth example embodiment, it is possible to provide a technique which makes it possible to suitably evaluate a weight of a target object which has been scooped up by an excavator and which is disposed in a container. Moreover, it is possible to further train the estimation model.

### Seventh Example Embodiment

(Configuration of Information Processing System 600)

Next, an information processing system 600 in accordance with a seventh example embodiment is described with reference to drawings. The information processing system 600 is a system which estimates a weight of earth and sand accommodated in a bucket 653 of a backhoe 65 and which trains an estimation model. Note that descriptions of elements having the same functions as those of the elements described in the first through sixth example embodiments will be omitted as appropriate.

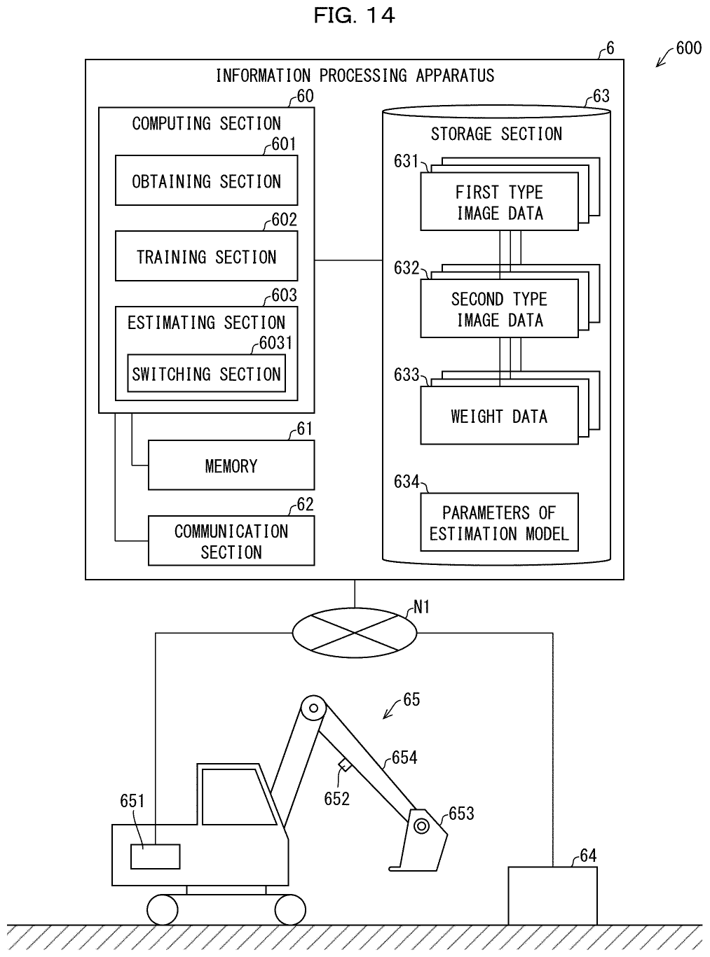

FIG. 14 is a block diagram illustrating a configuration of the information processing system 600. As illustrated in FIG. 14, the information processing system 600 includes an information processing apparatus 6. The information processing system 600 may further include a weight measurement apparatus 64 and the backhoe 65.

The information processing apparatus 6 includes a computing section 60, a memory 61, a communication section 62, and a storage section 63. The computing section 60 includes an obtaining section 601, a training section 602, and an estimating section 603. The obtaining section 601 and the training section 602 are equivalent to the obtaining section 501 and the training section 502, respectively, described in the sixth example embodiment. Therefore, descriptions of these sections are omitted. Configurations of the memory 61, the communication section 62, the storage section 63, the backhoe 65, and the weight measurement apparatus 64 are equivalent to respective configurations of the memory 51, the communication section 52, the storage section 53, the backhoe 55, and the weight measurement apparatus 54 described in the sixth example embodiment. Therefore, descriptions of these sections are omitted.

The information processing system 600 differs from the information processing system 500 in accordance with the sixth example embodiment in that the estimating section 603 includes a plurality of estimation models including a kernel ridge regression model and further includes a switching section 6031. In the storage section 63, parameters 634 of each of the plurality of estimation models that have been trained are recorded.

The switching section 6031 uses the kernel ridge regression model, depending on accuracy of training of the estimation models. As an example, in accordance with a value of a kernel function that includes, as an argument, a value obtained from first image data 631 and second image data 632 which have been obtained by the obtaining section 601, the switching section 6031 determines which one of the kernel ridge regression model and an estimation model other than the kernel ridge regression model is to be used as an estimation model, and switches the estimation model to be used between these models.

As an example, the switching section 6031 refers to a value of

k(x,xi)

which appears on the right side of the equation (19) described above and which is a kernel function that includes, as an argument x, a value obtained from the first image data 631 and the second image data 632 which have been obtained by the obtaining section 601. In accordance with the value, the switching section 6031 switches the estimation model to be used between the kernel ridge regression model and the estimation model other than the kernel ridge regression model.

As described above, the kernel ridge regression estimation model makes it possible to obtain a smaller RMSE. Furthermore, a maximum error is also smaller than those produced by the other models. Note, however, that, in the case of a regression model that is based on a norm in a high-dimensional space, such as the kernel ridge regression model, data used to train the regression model (hereinafter, simply referred to as learning data) may become sparse and thus accuracy may decrease. That is, in a case where there is a little learning data and there is no learning data in a vicinity of data that is to be estimated, estimation accuracy may decrease.

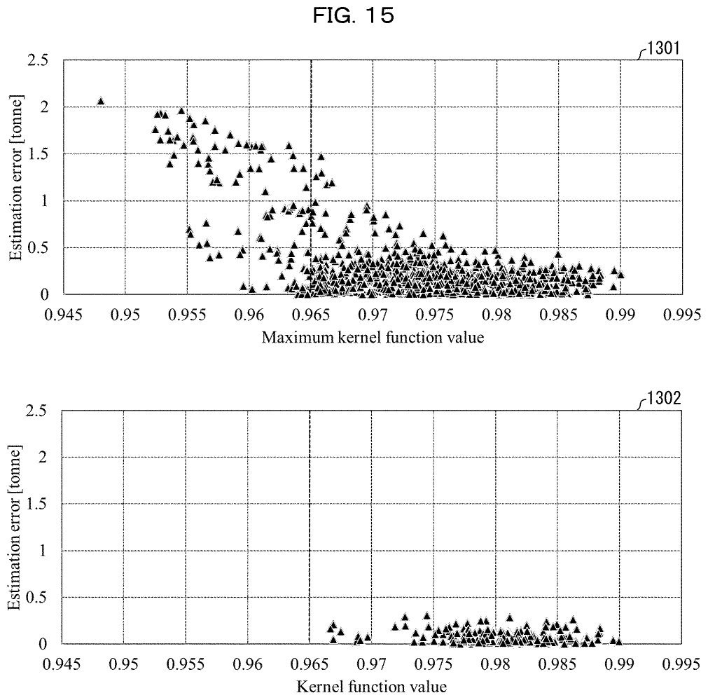

In a case where learning data xi is not present in a vicinity of data x relating to the earth and sand which are an estimation target, a maximum value of the kernel function k(x, xi) becomes a small numerical value. FIG. 15 illustrates graphs each showing a relationship between the maximum value of the kernel function and an estimation error. 1301 of FIG. 15 is a graph in a case where there is a little learning data, and 1302 of FIG. 15 is a graph in a case where there are much learning data. As shown in 1301, an error in an estimated value tends to be large in a case where the maximum value of the kernel function is less than 0.965. In contrast, in a case where there are much learning data, the maximum value of the kernel function is 0.965 or more in all cases.

In such a case, for example, the maximum value of the kernel function can be used as a criterion for determining which one of the kernel ridge regression model and the estimation model other than the kernel ridge regression model is to be used. Specifically, first, the estimating section 603 calculates the kernel function k(x, xi) described above for each i (i=1 to N), and then determines the maximum value of the kernel function. Next, the switching section 6031 determines whether or not the maximum value is 0.965 or more. In a case where it is determined that the maximum value is 0.965 or more, the switching section 6031 selects the kernel ridge regression model as the estimation model. In a case where it is determined that the maximum value is less than 0.965, the switching section 6031 selects, as the estimation model, the model other than the kernel ridge regression model. As the model other than the kernel ridge regression model, a theoretical equation model can be used, for example. Note that a determination value is not necessarily the maximum value of the kernel function. Note also that the above determination value of 0.965 is merely an example, and the determination value can be set as appropriate in accordance with various conditions.

(Effects of Information Processing System 600)

As has been described, the switching section 6031 employs a configuration such that the switching section 6031 can switch an estimation model to be used between a kernel ridge regression model and an estimation model other than the kernel ridge regression model, in accordance with a value of a kernel function that includes, as an argument, a value obtained from first image data and second image data.

Therefore, according to the information processing system 600 in accordance with the seventh example embodiment, it is possible to provide a technique which makes it possible to suitably evaluate a weight of a target object which has been scooped up by an excavator and which is disposed in a container. Moreover, since a more accurate estimation model is selected and the estimation model is switched to the more accurate estimation model, an effect that it is possible to improve weight estimation accuracy is brought about.

### Eighth Example Embodiment

(Configuration of Information Processing System 700)

Next, an information processing system 700 in accordance with an eighth example embodiment is described with reference to drawings. The information processing system 700 is a system which estimates a weight of earth and sand accommodated in a bucket 763 of a backhoe 76 and which trains an estimation model. Note that descriptions of elements having the same functions as those of the elements described in the first through seventh example embodiments will be omitted as appropriate.

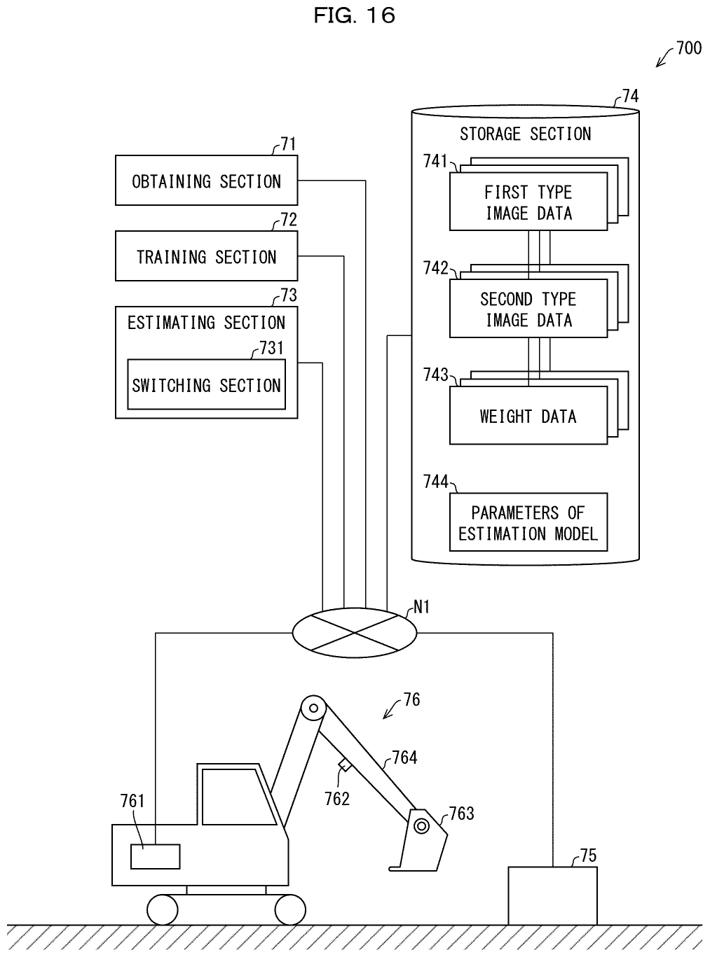

FIG. 16 is a block diagram illustrating a configuration of the information processing system 700. As illustrated in FIG. 16, the information processing system 700 includes an obtaining section 71, a training section 72, an estimating section 73, and a storage section 74. The estimating section 73 includes a switching section 731. First type image data 741, second type image data 742, weight data 743, and parameters 744 of the estimation model are recorded in the storage section 74. Configurations of the obtaining section 71, the training section 72, the estimating section 73, and the storage section 74 are similar to respective configurations of the obtaining section 601, the training section 602, the estimating section 603, and the storage section 63 described in the seventh example embodiment. Furthermore, operations of the obtaining section 71, the training section 72, the estimating section 73, and the storage section 74 are similar to respective operations of the obtaining section 601, the training section 602, the estimating section 603, and the storage section 63 described in the seventh example embodiment.

The information processing system 700 may further include a weight measurement apparatus 75 and the backhoe 76. Configurations of the weight measurement apparatus 75 and the backhoe 76 are similar to respective configurations of the weight measurement apparatus 64 and the backhoe 65 described in the seventh example embodiment. Operations of the weight measurement apparatus 75 and the backhoe 76 are similar to respective operations of the weight measurement apparatus 64 and the backhoe 65 described in the seventh example embodiment. The obtaining section 71, the training section 72, the estimating section 73, and the storage section 74 can each carry out data communication with the weight measurement apparatus 75 and the backhoe 76 via a wireless communication network N1.

The information processing system 700 in accordance with the eighth example embodiment differs from the information processing system 600 in accordance with the seventh example embodiment in that the obtaining section 71, the training section 72, the estimating section 73, and the storage section 74 of the information processing system 700 are disposed in a dispersed manner and can carry out data communication with each other via the wireless communication network N1. The obtaining section 71, the training section 72, the estimating section 73, and the storage section 74 may be capable of, independently of each other, carrying out data communication with the weight measurement apparatus 75 and the backhoe 76. A part or all of the obtaining section 71, the training section 72, the estimating section 73, and the storage section 74 may be disposed on a cloud. Although not illustrated, the obtaining section 71, the training section 72, the estimating section 73, and the storage section 74 each include a communication section. The obtaining section 71, the training section 72, and the estimating section 73 each include a memory.

(Effects of Information Processing System 700)

As has been described, the obtaining section 71, the training section 72, the estimating section 73, and the storage section 74 of the information processing system 700 are disposed in a dispersed manner, and are configured to be capable of carrying out data communication with each other. The obtaining section 71, the training section 72, the estimating section 73, and the storage section 74 may be each capable of carrying out data communication with the weight measurement apparatus 75 and the backhoe 76.

Therefore, according to the information processing system 700 in accordance with the eighth example embodiment, it is possible to provide a technique which makes it possible to suitably evaluate a weight of a target object which has been scooped up by an excavator and which is disposed in a container. Moreover, it is possible to further train an estimation model. Furthermore, it is possible to dispose the elements of the information processing system 700 in a dispersed manner, and possible to dispose, as appropriate, the elements at respective any positions. This brings about an effect that a degree of freedom of a system configuration is improved.

[Software Implementation Example]

A part or all of the functions of the training apparatuses 1 and 3, the estimation apparatuses 2 and 4, the information processing apparatuses 5 and 6, the weight estimation apparatus 100, and the information processing systems 500, 600, and 700 or a part or all of the functions of the obtaining sections (first obtaining section, second obtaining section), the training sections, the estimating sections, the computing sections, and the like of these apparatuses and systems (hereinafter, these are referred to as “training apparatus 1 etc.”) may be realized by hardware such as an integrated circuit (IC chip) or may be alternatively realized by software.

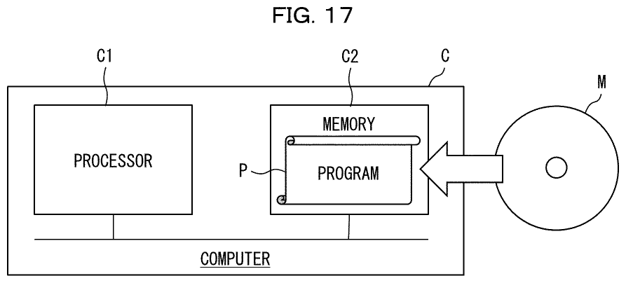

In the latter case, the training apparatus 1 etc. are realized by, for example, a computer that executes instructions of a program that is software realizing the functions. FIG. 17 illustrates an example of such a computer (hereinafter, referred to as “computer C”). The computer C includes at least one processor C1 and at least one memory C2. In the memory C2, a program P for causing the computer C to operate as the training apparatus 1 etc. is recorded. In the computer C, the functions of the training apparatus 1 etc. are realized by the processor C1 reading the program P from the memory C2 and executing the program P.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can acquire the program P via such a recording medium M. The program P can also be transmitted via a transmission medium. Such a transmission medium can be, for example, a communication network, a broadcast wave, or the like. The computer C can acquire the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as follows. Note, however, that the present invention is not limited to the following example aspects.

### (Supplementary Note 1)

A training method including: obtaining first type image data that is image data on a target object which has been scooped up by an excavator and which is disposed in a container; and training, with reference to the first type image data and a measured weight of the target object, an estimation model that estimates a weight of the target object.

According to the above configuration, it is possible to provide a training method which makes it possible to suitably evaluate a weight of a target object disposed in a container.

### (Supplementary Note 2)

The training method as described in Supplementary note 1, wherein, in the training step, the estimation model is trained with reference to second type image data that is image data on an inside of the container in a situation where the target object is not disposed therein.

According to the above configuration, it is possible to train the estimation model with higher accuracy, by referring to the second type image data.

### (Supplementary Note 3)

The training method as described in Supplementary note 1 or 2, wherein the image data is data indicating a distance between an image capturing means and the target object.

According to the above configuration, it is possible to train the model that estimates the weight of the target object, with use of distance data which has been obtained by the image capturing means.

### (Supplementary Note 4)

The training method as described in Supplementary note 3, wherein the estimation model includes a regression model in which a value obtained from the first type image data and the second type image data is an explanatory variable and the weight of the target object is a response variable.

According to the above configuration, it is possible to train the estimation model with higher accuracy, by using the regression model as the estimation model.

### (Supplementary Note 5)

The training method as described in Supplementary note 4, wherein the regression model includes a kernel ridge regression model.

According to the above configuration, it is possible to train the estimation model with higher accuracy, by using the kernel ridge regression model as the estimation model.

### (Supplementary Note 6)

A training apparatus including: an obtaining means for obtaining first type image data that is image data on a target object which has been scooped up by an excavator and which is disposed in a container; and a training means for training, with reference to the first type image data and a measured weight of the target object, an estimation model that estimates a weight of the target object.

According to the above configuration, it is possible to provide a training apparatus which makes it possible to suitably evaluate a weight of a target object disposed in a container.

### (Supplementary Note 7)

The training apparatus as described in Supplementary note 6, wherein the training means trains the estimation model with reference to second type image data that is image data on an inside of the container in a situation where the target object is not disposed therein.

According to the above configuration, it is possible to provide a training apparatus for an estimation model with higher accuracy, by referring to the second type image data.

### (Supplementary Note 8)

The training apparatus as described in Supplementary note 6 or 7, wherein the image data is data indicating a distance between an image capturing means and the target object.

According to the above configuration, it is possible to provide a training apparatus for a model that estimates a weight of a target object with use of distance data which has been obtained by an image capturing means.

### (Supplementary Note 9)

The training apparatus as described in Supplementary note 8, wherein the estimation model includes a regression model in which a value obtained from the first type image data and the second type image data is an explanatory variable and the weight of the target object is a response variable.

According to the above configuration, it is possible to provide a training apparatus for an estimation model with higher accuracy, by using the regression model as the estimation model.

### (Supplementary Note 10)

The training apparatus as described in Supplementary note 9, wherein the regression model includes a kernel ridge regression model.

According to the above configuration, it is possible to provide a training apparatus for an estimation model with higher accuracy, by using the kernel ridge regression model as the estimation model.

### (Supplementary Note 11)

A training system including: an obtaining means for obtaining first type image data that is image data on a target object which has been scooped up by an excavator and which is disposed in a container; and a training means for training, with reference to the first type image data and a measured weight of the target object, an estimation model that estimates a weight of the target object.

According to the above configuration, it is possible to provide a training system which makes it possible to suitably evaluate a weight of a target object disposed in a container.

### (Supplementary Note 12)

The training system as described in Supplementary note 11, wherein the training means trains the estimation model further with reference to second type image data that is image data on an inside of the container in a situation where the target object is not disposed therein.

According to the above configuration, it is possible to provide a training system for an estimation model with higher accuracy, by referring to the second type image data.

### (Supplementary Note 13)

The training system as described in Supplementary note 11, wherein the image data is data indicating a distance between an image capturing means and the target object.

According to the above configuration, it is possible to provide a training system for a model that estimates a weight of a target object with use of distance data which has been obtained by an image capturing means.

### (Supplementary Note 14)

The training system as described in Supplementary note 13, wherein the estimation model includes a regression model in which a value obtained from the first type image data and the second type image data is an explanatory variable and the weight of the target object is a response variable.

According to the above configuration, it is possible to provide a training system for an estimation model with higher accuracy, by using the regression model as the estimation model.

### (Supplementary Note 15)

The training system as described in Supplementary note 14, wherein the regression model includes a kernel ridge regression model.

According to the above configuration, it is possible to provide a training system for an estimation model with higher accuracy, by using the kernel ridge regression model as the estimation model.

### (Supplementary Note 16)

An estimation method of estimating a weight of a target object which has been scooped up by an excavator and which is disposed in a container, the method including: obtaining first type image data that is image data on the target object which is disposed in the container; and estimating the weight of the target object with use of an estimation model that outputs the weight of the target object based on the first type image data.

According to the above configuration, it is possible to provide an estimation method which makes it possible to suitably evaluate a weight of a target object disposed in a container.

### (Supplementary Note 17)

The estimation method as described in Supplementary note 16, wherein the image data is data indicating a distance between an image capturing means and the target object.

According to the above configuration, it is possible to provide an estimation method of estimating a weight of a target object with use of distance data which has been obtained by an image capturing means.

### (Supplementary Note 18)

The estimation method as described in Supplementary note 16 or 17, wherein: in the obtaining step, second type image data is further obtained which is image data on an inside of the container in a situation where the target object is not disposed therein; and in the estimating step, the weight of the target object is estimated with use of, as the estimation model, a model that outputs the weight of the target object based on the first type image data and the second type image data.

According to the above configuration, it is possible to provide an estimation method with higher accuracy, by referring to the second type image data.

### (Supplementary Note 19)

The estimation method as described in Supplementary note 18, wherein the estimation model includes a theoretical equation that derives the weight of the target object from a value obtained from the first type image data and the second type image data.

According to the above configuration, it is possible to provide an estimation method in which a theoretical equation model is used as an estimation model. The theoretical equation model can be suitably used in a case where an error produced by a regression model is large.

### (Supplementary Note 20)

The estimation method as described in Supplementary note 18 or 19, wherein the estimation model includes a regression model in which a value obtained from the first type image data and the second type image data is an explanatory variable and the weight of the target object is a response variable.

According to the above configuration, it is possible to provide an estimation method with higher accuracy, by using the regression model as the estimation model.

### (Supplementary Note 21)

The estimation method as described in Supplementary note 20, wherein the estimation model includes a kernel ridge regression model.

According to the above configuration, it is possible to provide an estimation method with higher accuracy, by using the kernel ridge regression model as the estimation model.

### (Supplementary Note 22)

The estimation method as described in Supplementary note 21, wherein in the estimating step, any one of the kernel ridge regression model and an estimation model other than the kernel ridge regression model is used as the estimation model, in accordance with a value of a kernel function that includes, as an argument, the value obtained from the first type image data and the second type image data which have been obtained in the obtaining step.

According to the above configuration, it is possible to provide an estimation method which makes it possible to cause an error to be small by switching to an estimation model other than a kernel ridge regression model in a case where an error in estimation by the kernel ridge regression model is large.

### (Supplementary Note 23)

The estimation method as described in any one of Supplementary notes 16 through 22, wherein the estimation method includes training the estimation model with reference to at least a measured weight of the target object and the first type image data that is image data on the target object which has been scooped up by the excavator and which is disposed in the container.

According to the above configuration, it is possible to carry out estimation with use of a trained estimation model. Furthermore, it is possible to provide an estimation method which makes it possible to cause the estimation model to be more accurate by further training the estimation model.

[Additional Remark 3]

The whole or part of the example embodiments disclosed above can also be expressed as follows.

A training apparatus for an estimation model that estimates a weight of a target object which has been scooped up by an excavator and which is disposed in a container, the training apparatus including at least one processor, the at least one processor carrying out: an obtaining process of obtaining first type image data that is image data on the target object which is disposed in the container; and a training process of training, with reference to the first type image data and a measured weight of the target object, the estimation model that estimates the weight of the target object.

Note that this training apparatus may further include a memory, and, in this memory, a program may be stored which is for causing the at least one processor to carry out the obtaining process and the training process.

A program for causing a computer to function as a means for training an estimation model that estimates a weight of a target object which has been scooped up by an excavator and which is disposed in a container, the program causing the computer to function as: an obtaining means for obtaining first type image data that is image data on the target object which is disposed in the container; and a training means for training, with reference to the first type image data and a measured weight of the target object, the estimation model that estimates the weight of the target object.

A program for causing a computer to function as a means for estimating a weight of a target object which has been scooped up by an excavator and which is disposed in a container, the program causing the computer to function as: an obtaining means for obtaining first type image data that is image data on the target object which is disposed in the container; and an estimating means for estimating the weight of the target object with use of an estimation model that outputs the weight of the target object based on the first type image data.

The above programs may be each recorded in a computer-readable non-transitory tangible recording medium.

[Additional Remark 4]

The whole or part of the example embodiments disclosed above can be described as follows. Note, however, that the present invention is not limited to the following example aspects.

### (Supplementary Note 101)

A weight estimation method including: a first obtaining step of obtaining first image data which is image data for training and which is included in first type image data that is image data on a target object which has been scooped up by an excavator and which is disposed in a container; a training step of training, with reference to the first image data and a measured weight of the target object, an estimation model that outputs a weight of the target object based on the first type image data; a second obtaining step of obtaining second image data which is image data for estimation and which is included in the first type image data; and an estimating step of estimating the weight of the target object based on the estimation model and the second image data.

### (Supplementary Note 102)

The weight estimation method as described in Supplementary note 101, wherein: in the first obtaining step, third image data is further obtained which is image data for training and which is included in second type image data that is image data on an inside of the container before the target object is scooped up; the estimation model outputs the weight of the target object based on the first type image data and the second type image data; in the training step, the estimation model is trained further with reference to the third image data; in the second obtaining step, fourth image data is further obtained which is image data for estimation and which is included in the second type image data; and in the estimating step, the weight of the target object is estimated based on the estimation model, the second image data, and the fourth image data.

### (Supplementary Note 103)

The weight estimation method as described in Supplementary note 102, wherein the first type image data and the second image data are each data indicating a distance between an image capturing means and the target object.

### (Supplementary Note 104)

The weight estimation method as described in Supplementary note 102 or 103, wherein the estimation model includes a theoretical equation that derives the weight of the target object from a value obtained from the first type image data and the second type image data.

### (Supplementary Note 105)

The weight estimation method as described in any one of Supplementary notes 102 through 104, wherein the estimation model includes a regression model in which a value obtained from the first type image data and the second type image data is an explanatory variable and the weight of the target object is a response variable.

### (Supplementary Note 106)

The weight estimation method as described in Supplementary note 105, wherein in the estimating step, a kernel ridge regression model is used, depending on accuracy of training of the estimation model.

### (Supplementary Note 107)

The weight estimation method as described in Supplementary note 106, wherein in the estimating step, any one of the kernel ridge regression model and an estimation model other than the kernel ridge regression model is used as the estimation model, in accordance with a value of a kernel function that includes, as an argument, the value obtained from the first type image data and the second type image data which have been obtained in the second obtaining step.

### (Supplementary Note 108)

A weight estimation apparatus including: a first obtaining means for obtaining first image data which is image data for training and which is included in first type image data that is image data on a target object which has been scooped up by an excavator and which is disposed in a container; a training means for training, with reference to the first image data and a measured weight of the target object, an estimation model that outputs a weight of the target object based on the first type image data; a second obtaining means for obtaining second image data which is image data for estimation and which is included in the first type image data; and an estimating means for estimating the weight of the target object based on the estimation model and the second image data.

### (Supplementary Note 109)

The weight estimation apparatus as described in Supplementary note 108, wherein: the first obtaining means further obtains third image data which is image data for training and which is included in second type image data that is image data on an inside of the container before the target object is scooped up; the estimation model outputs the weight of the target object based on the first type image data and the second type image data; the training means trains the estimation model further with reference to the third image data; the second obtaining means further obtains fourth image data which is image data for estimation and which is included in the second type image data; and the estimating means estimates the weight of the target object based on the estimation model, the second image data, and the fourth image data.

### (Supplementary Note 110)

The weight estimation apparatus as described in Supplementary note 109, wherein the first type image data and the second image data are each data indicating a distance between an image capturing means and the target object.

### (Supplementary Note 111)

The weight estimation apparatus as described in Supplementary note 109 or 110, wherein the estimation model includes a theoretical equation that derives the weight of the target object from a value obtained from the first type image data and the second type image data.

### (Supplementary Note 112)

The weight estimation apparatus as described in any one of Supplementary notes 109 through 111, wherein the estimation model includes a regression model in which a value obtained from the first type image data and the second type image data is an explanatory variable and the weight of the target object is a response variable.

### (Supplementary Note 113)

The weight estimation apparatus as described in Supplementary note 112, wherein the estimating means uses a kernel ridge regression model, depending on accuracy of training of the estimation model.

### (Supplementary Note 114)

The weight estimation apparatus as described in Supplementary note 113, wherein the estimating means uses, as the estimation model, any one of the kernel ridge regression model and an estimation model other than the kernel ridge regression model, in accordance with a value of a kernel function that includes, as an argument, the value obtained from the first type image data and the second type image data which have been obtained by the second obtaining means.

### (Supplementary Note 115)

A weight estimation system including: a first obtaining means for obtaining first image data which is image data for training and which is included in first type image data that is image data on a target object which has been scooped up by an excavator and which is disposed in a container; a training means for training, with reference to the first image data and a measured weight of the target object, an estimation model that outputs a weight of the target object based on the first type image data; a second obtaining means for obtaining second image data which is image data for estimation and which is included in the first type image data; and an estimating means for estimating the weight of the target object based on the estimation model and the second image data.

### (Supplementary Note 116)

The weight estimation system as described in Supplementary note 115, wherein: the first obtaining means further obtains third image data which is image data for training and which is included in second type image data that is image data on an inside of the container before the target object is scooped up; the estimation model outputs the weight of the target object based on the first type image data and the second type image data; the training means trains the estimation model further with reference to the third image data; the second obtaining means further obtains fourth image data which is image data for estimation and which is included in the second type image data; and the estimating means estimates the weight of the target object based on the estimation model, the second image data, and the fourth image data.

### (Supplementary Note 117)

The weight estimation system as described in Supplementary note 116, wherein the first type image data and the second image data are each data indicating a distance between an image capturing means and the target object.

### (Supplementary Note 118)

The weight estimation system as described in Supplementary note 116 or 117, wherein the estimation model includes a theoretical equation that derives the weight of the target object from a value obtained from the first type image data and the second type image data.

### (Supplementary Note 119)

The weight estimation system as described in any one of Supplementary notes 116 through 118, wherein the estimation model includes a regression model in which a value obtained from the first type image data and the second type image data is an explanatory variable and the weight of the target object is a response variable.

### (Supplementary Note 120)

The weight estimation system as described in Supplementary note 119, wherein the estimating means uses a kernel ridge regression model, depending on accuracy of training of the estimation model.

### (Supplementary Note 121)

The weight estimation system as described in Supplementary note 120, wherein the estimating means uses, as the estimation model, any one of the kernel ridge regression model and an estimation model other than the kernel ridge regression model, in accordance with a value of a kernel function that includes, as an argument, the value obtained from the first type image data and the second type image data which have been obtained by the second obtaining means.

[Additional Remark 5]

The whole or part of the example embodiments disclosed above can also be expressed as follows.

A weight estimation apparatus including at least one processor, the at least one processor carrying out: a first obtaining process of obtaining first image data which is image data for training and which is included in first type image data that is image data on a target object which has been scooped up by an excavator and which is disposed in a container; a training process of training, with reference to the first image data and a measured weight of the target object, an estimation model that outputs a weight of the target object based on the first type image data; a second obtaining process of obtaining second image data which is image data for estimation and which is included in the first type image data; and an estimating process of estimating the weight of the target object based on the estimation model and the second image data.

Note that this weight estimation apparatus may further include a memory, and, in this memory, a program may be stored which is for causing the at least one processor to carry out the first obtaining process, the training process, the second obtaining process, and the estimating process.

A program for causing a computer to function as: a first obtaining means for obtaining first image data which is image data for training and which is included in first type image data that is image data on a target object which has been scooped up by an excavator and which is disposed in a container; a training means for training, with reference to the first image data and a measured weight of the target object, an estimation model that outputs a weight of the target object based on the first type image data; a second obtaining means for obtaining second image data which is image data for estimation and which is included in the first type image data; and an estimating means for estimating the weight of the target object based on the estimation model and the second image data.

### REFERENCE SIGNS LIST

1,3 Training apparatus
10, 20, 301, 401, 501, 601 Obtaining section
11, 102, 302, 502, 602, 72 Training section
2, 4 Estimation apparatus
21, 104, 402, 503, 603, 73 Estimating section
31, 41, 51, 61 Memory
32, 42, 52, 62 Communication section
33, 43, 53, 63, 74 Storage section
40, 50, 60 Computing section
5, 6 Information processing apparatus
100 Weight estimation apparatus
101 First obtaining section
103 Second obtaining section
300 Training system
400 Estimation system
331, 531, 631, 741 First type image data
332, 532, 632, 742 Second type image data
333, 533, 633, 743 Weight data
334, 431, 534, 634, 744 Parameters of estimation model
35, 44, 55, 65, 76 Backhoe
34, 54, 64, 75 Weight measurement apparatus
351, 441, 551, 651, 761 Controller
352, 442, 552, 652, 762 Depth camera
353, 443, 553, 653, 763 Bucket
354, 444, 554, 654, 764 Arm
500, 600, 700 Information processing system

What is claimed is:

1. A weight estimation method comprising:
a first obtaining step of obtaining first image data which is image data for training and which is included in first type image data that is image data on a target object which has been scooped up by an excavator and which is disposed in a container;
a training step of training, with reference to the first image data and a measured weight of the target object, an estimation model that outputs a weight of the target object based on the first type image data;
a second obtaining step of obtaining second image data which is image data for estimation and which is included in the first type image data; and
an estimating step of estimating the weight of the target object based on the estimation model and the second image data.

2. The weight estimation method as set forth in claim 1, wherein:
in the first obtaining step, third image data is further obtained which is image data for training and which is included in second type image data that is image data on an inside of the container before the target object is scooped up;
the estimation model outputs the weight of the target object based on the first type image data and the second type image data;
in the training step, the estimation model is trained further with reference to the third image data;
in the second obtaining step, fourth image data is further obtained which is image data for estimation and which is included in the second type image data; and
in the estimating step, the weight of the target object is estimated based on the estimation model, the second image data, and the fourth image data.

3. The weight estimation method as set forth in claim 2, wherein the first type image data and the second image data are each data indicating a distance between an image capturing means and the target object.

4. The weight estimation method as set forth in claim 2, wherein the estimation model includes a theoretical equation that derives the weight of the target object from a value obtained from the first type image data and the second type image data.

5. The weight estimation method as set forth in claim 2, wherein the estimation model includes a regression model in which a value obtained from the first type image data and the second type image data is an explanatory variable and the weight of the target object is a response variable.

6. The weight estimation method as set forth in claim 5, wherein in the estimating step, a kernel ridge regression model is used, depending on accuracy of training of the estimation model.

7. The weight estimation method as set forth in claim 6, wherein in the estimating step, any one of the kernel ridge regression model and an estimation model other than the kernel ridge regression model is used as the estimation model, in accordance with a value of a kernel function that includes, as an argument, the value obtained from the first type image data and the second type image data which have been obtained in the second obtaining step.

8. A weight estimation apparatus comprising:
at least one processor,
the at least one processor carrying out:
a first obtaining process of obtaining first image data which is image data for training and which is included in first type image data that is image data on a target object which has been scooped up by an excavator and which is disposed in a container;
a training process of training, with reference to the first image data and a measured weight of the target object, an estimation model that outputs a weight of the target object based on the first type image data;
a second obtaining process of obtaining second image data which is image data for estimation and which is included in the first type image data; and
an estimating process of estimating the weight of the target object based on the estimation model and the second image data.

9. The weight estimation apparatus as set forth in claim 8, wherein:
in the first obtaining process, the at least one processor further obtains third image data which is image data for training and which is included in second type image data that is image data on an inside of the container before the target object is scooped up;
the estimation model outputs the weight of the target object based on the first type image data and the second type image data;
in the training process, the at least one processor trains the estimation model further with reference to the third image data;
in the second obtaining process, the at least one processor further obtains fourth image data which is image data for estimation and which is included in the second type image data; and
in the estimating process, the at least one processor estimates the weight of the target object based on the estimation model, the second image data, and the fourth image data.

10. The weight estimation apparatus as set forth in claim 9, wherein the first type image data and the second image data are each data indicating a distance between an image capturing means and the target object.

11. The weight estimation apparatus as set forth in claim 9, wherein the estimation model includes a theoretical equation that derives the weight of the target object from a value obtained from the first type image data and the second type image data.

12. The weight estimation apparatus as set forth in claim 9, wherein the estimation model includes a regression model in which a value obtained from the first type image data and the second type image data is an explanatory variable and the weight of the target object is a response variable.

13. The weight estimation apparatus as set forth in claim 12, wherein in the estimating process, the at least one processor uses a kernel ridge regression model, depending on accuracy of training of the estimation model.

14. The weight estimation apparatus as set forth in claim 13, wherein in the estimating process, the at least one processor uses, as the estimation model, any one of the kernel ridge regression model and an estimation model other than the kernel ridge regression model, in accordance with a value of a kernel function that includes, as an argument, the value obtained from the first type image data and the second type image data which have been obtained in the second obtaining process.

15-21. (canceled)

22. A non-transitory recording medium in which a program is recoded, the program being for causing a computer to carry out:
a first obtaining process of obtaining first image data which is image data for training and which is included in first type image data that is image data on a target object which has been scooped up by an excavator and which is disposed in a container;
a training process of training, with reference to the first image data and a measured weight of the target object, an estimation model that outputs a weight of the target object based on the first type image data;
a second obtaining process of obtaining second image data which is image data for estimation and which is included in the first type image data; and
an estimating process of estimating the weight of the target object based on the estimation model and the second image data.
